(19) United States
(12) Patent Application Publication
(10) Pub. No.: US 2008/0163282 A1
(43) Pub. Date: Jul. 3, 2008

(54) APPARATUS AND SYSTEM FOR MULTIMEDIA MEDITATION

(75) Inventors: Erika Reponen, Tampere (FI); Merja Haveri, Lempaala (FI)

Correspondence Address: PERMAN & GREEN, 425 POST ROAD, FAIRFIELD, CT, 06824, US

(73) Assignee: Nokia Corporation, Espoo (FI)

(21) Appl. No.: 11/618,093

(22) Filed: Dec. 29, 2006

(51) Int. Cl. H04H 9/00

(52) U.S. Cl. 725/9

(57) ABSTRACT

An apparatus including a speaker, a display, a processor in communication with the speaker and display and a memory module in communication with the processor for at least storing at least one presentation executable by the processor, wherein the at least one presentation is configured to modify a mood of a user, and wherein the processor is configured send or receive the at least one presentation to or from another apparatus and to cause a presentation of at least one presentation to the user.

### BACKGROUND

1. Field

The disclosed embodiments relate to communication devices and, more particularly, to using a communication device for mood enhancement.

2. Brief Description of Related Developments

In today's world individuals are becoming increasingly involved with their jobs or are otherwise traveling at increasing rates which may lead to increased stress levels. Also, as travel costs increase more and more individuals are taking public transportation such as cabs, buses, trains and airplanes. This increased travel inevitably means more contact with an increasing number of unknown people or other passengers. In the event one does not want to communicate with these unknown people or other passengers one would pretend to read messages, newspapers, books, play electronic games and the like in an effort to avoid communication with other people. Pretending to be busy and hoping no other passengers disturb you may also lead to increased annoyance and stress for some travelers.

It would be advantageous for a traveler to be able to engage in an activity that would at least make it appear to other passengers that they are busy and do not want to be disturbed, while at the same time reducing anxiety and stress levels for the traveler.

### SUMMARY

In one embodiment, an apparatus is provided. The apparatus includes a speaker, a display, a processor in communication with the speaker and display and a memory module in communication with the processor for at least storing at least one presentation executable by the processor, wherein the at least one presentation is configured to modify a mood of a user, and wherein the processor is configured send or receive the at least one presentation to or from another apparatus and to cause a presentation of at least one presentation to the user.

In another embodiment, a method is provided. The method includes sending at least one presentation from a first device to a second device, receiving the at least one presentation in the second device and presenting through the second device the at least one presentation including at least one of sounds and visual stimuli to a user to modify a mood of the user.

In one embodiment, a computer program product is provided. The computer program product includes a computer useable medium having computer readable code means embodied therein for causing a computer to modify a mood of a user. The computer readable code means in the computer program product includes computer readable program code means for causing a computer to send at least one presentation from a first device to a second device, computer readable program code means for causing a computer to receive the at least one presentation in the second device and computer readable program code means for causing a computer to present through the second device the at least one presentation including at least one of sounds and visual stimuli to a user to modify a mood of the user.

### BRIEF DESCRIPTION OF THE DRAWINGS

The foregoing aspects and other features of the disclosed embodiments are explained in the following description, taken in connection with the accompanying drawings, wherein:

FIG. 1 shows an exemplary terminal in accordance with an embodiment;

FIG. 2 illustrates device interaction in accordance with an embodiment;

FIG. 3 is a schematic representation of the operation of a device in accordance with an embodiment;

FIG. 4 is a flow chart in accordance with an embodiment;

FIG. 5 is another flow chart in accordance with an embodiment;

FIG. 6 is a schematic representation of the operation of a device in accordance with an embodiment;

FIG. 7 is a flow chart in accordance with an embodiment;

FIG. 8 is another flow chart in accordance with an embodiment;

FIG. 9 shows a device incorporating features of an embodiment;

FIG. 10 shows another device incorporating features of an embodiment;

FIG. 11 is a block diagram illustrating the general architecture of the exemplary mobile devices of FIGS. 2 and 3;

FIG. 12 is a schematic illustration of a cellular telecommunications system, as an example, of an environment in which a communications device incorporating features of an exemplary embodiment may be applied; and

FIG. 13 illustrates a block diagram of an example of an apparatus incorporating features that may be used to practice aspects of the disclosed embodiments.

### DETAILED DESCRIPTION OF THE EXEMPLARY EMBODIMENT(s)

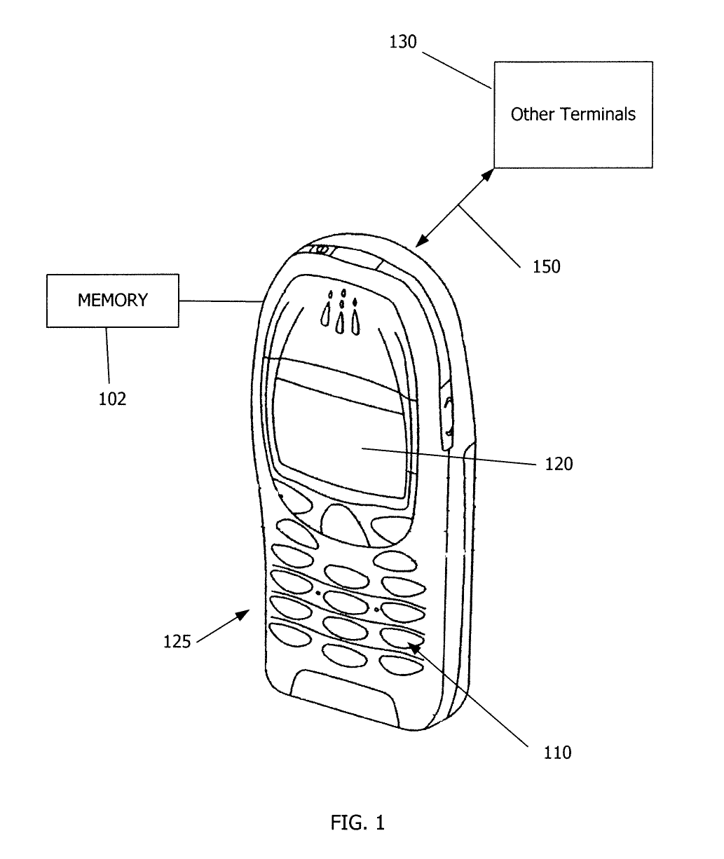

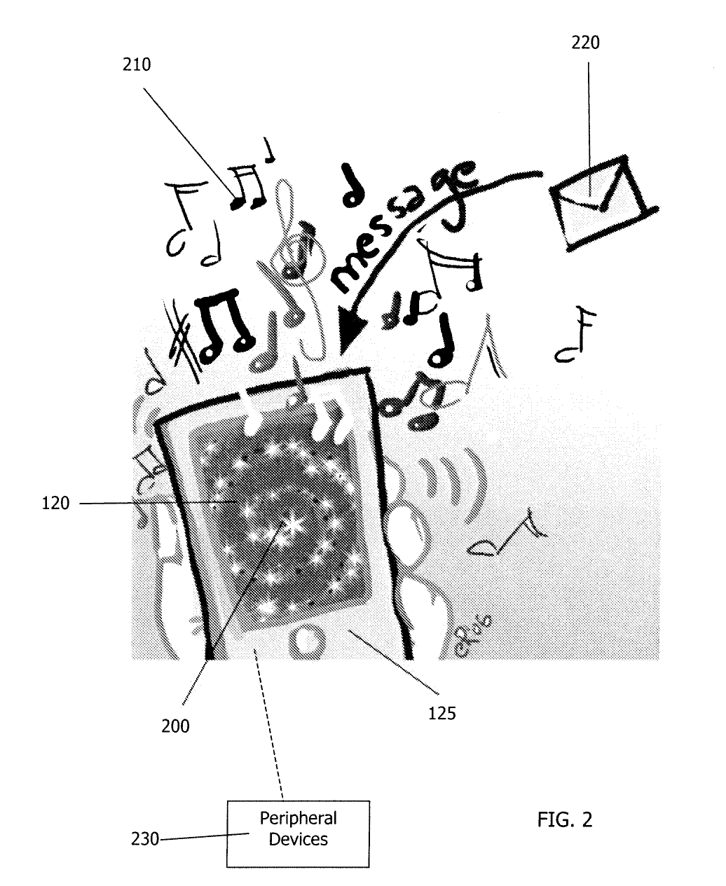

Referring to FIGS. 1 and 2, an exemplary terminal 125 and a schematic illustration of an interaction with the terminal 125 is shown in accordance with aspects of the disclosed embodiments. Although the embodiments disclosed will be described with reference to the embodiments shown in the drawings, it should be understood that the embodiments disclosed can be embodied in many alternate forms of embodiments. In addition, any suitable size, shape or type of elements or materials could be used.

The disclosed embodiments generally allow a user of a terminal to view, listen to or otherwise interact with relaxation/meditative presentations (the “presentations”). The disclosed embodiments may provide a way to impose any suitable effect on the user, such as a soothing, meditative or relaxing effect through several different media for the modification of a mood or state of mind of the user. For example the embodiments may allow a user to relax during a commute or at any other suitable time in such a way so as to at least make it appear to other individuals that the user does not want to be disturbed. The disclosed embodiments may also indicate to a user that a certain event should occur, such as, for example, the user getting off a bus or train, the ending of a lunch break, etc. The disclosed embodiments may also assist a user in relaxing at any point during the day when the user is not commuting.

Referring to FIGS. 1 and 2 the terminal may include a display 120, a keypad 110 and a memory 102. Other examples of terminals in which aspects of the embodiments can be used are described in greater detail below. Although the disclosed embodiments will be described with respect to terminal 125 it should be understood that the embodiments could be applied equally to any suitable device incorporating features including, but not limited to, a display, processor, memory and supporting software or hardware for implementing the disclosed embodiments.

The presentations can be downloaded using a web browser of the terminal 125, obtained from a memory 102 of the terminal 125, received from another terminal(s) 130 or any other external device via any suitable connection. The connection may be a wired connection or a wireless connection such as, for example communications network 150. The presentations may be received via the network 150 through any suitable type of communication such as, for example, a message 220 as can be seen in FIG. 2. In one embodiment, the user may manually or configure the terminal 125 to automatically download a “presentation of the day” that will be activated at, for example, a time specified by the user. In another embodiment, different presentations may be stored in the terminal to be randomly activated by the user so each time the user activates the relaxation/mediation function of the terminal a different presentation is played or otherwise outputted. In other embodiments the user may select which presentations are played or outputted at any given time. The presentations can take any suitable form such as visual stimuli 200, sounds or music 210, a lack of sound (e.g. silence through, for example a suitable noise canceling headset), vibration, tactile stimulation and the like to provide the user with, for example a soothing effect. The visual stimuli may be any suitable visual stimuli such as, for example, stimuli generated through suitable software of the device, predefined images, animations, videos, pictures, photographs, a color of the terminal changing (e.g. the terminal housing, a portion of the housing, a portion of the user interface, etc.) and the like. The sounds may be any suitable sounds such as, for example, user recorded sounds, pre-defined sounds, sounds generated through software of the terminal, music files, and the like.

The terminal 300 may be equipped with a settings menu that may allow the user to select a certain presentation, download presentations, create presentations and the like. The presentations may include any suitable themes such as, for example, predefined themes or user defined themes. For example, the predefined themes may include spiritual themes, rainforest themes, thunderstorm themes, waterfall themes, jungle themes, and the like. These themes may include any suitable sounds (or lack thereof via a suitable headset) and/or visualizations as well as any suitable tactile feedback. For example, the thunderstorm theme may include sounds of rain and thunder and soft hues of randomized color patterns 200 on the display 320 such as those shown in FIG. 2. In alternate embodiments, the presentation may be theme independent.

The user defined presentations and/or the downloaded or otherwise predefined presentations may incorporate any suitable sounds, visualizations and tactile feedback. The sounds, visualizations and tactile feedback may be obtained via the web, downloaded from another device or created using the user's terminal. In one example, the user may download sound clips from the web and create his/her own visual stimuli from within the terminal. The user may combine the downloaded sound clips and the visual stimuli into a presentation using, for example, any suitable settings menu of the terminal 125. The user may also combine tactile feedback with the sound and visual stimuli through any suitable settings menu. For example, the user may create a presentation that includes the sound of rain with no visual stimuli and with tactile feedback such as having the keys of the terminal massage the user's hands.

In another example, one user may send a presentation to a user of a different device. For example, one user, such as a user's wife, may create or download a presentation in her terminal, such as terminal 130. The presentation may be any suitable presentation. In this example, the wife may create a presentation that may include soft music, her voice and any suitable visual display. The wife may then send the presentation via, for example, a message 220 via any suitable network 150 to her husband's terminal, such as terminal 125 for her husband to listen to on his ride home from work so that he is a certain mood when he arrives at home. When, for example the presentation is received via, for example, a suitable message 200 the presentation may play or be output upon receipt of the message or it may be played or output upon activation by the user. In alternate embodiments presentations received by a message may be played or output at any suitable time. The user defined themes may also be combined with the predefined themes to create additional themes.

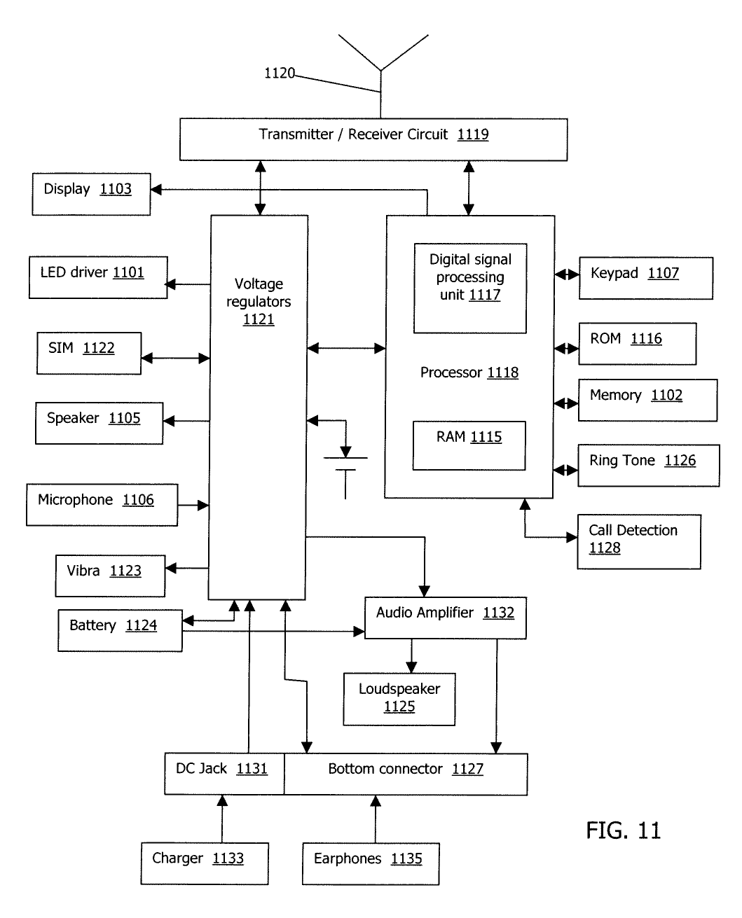

The tactile feedback for the presentations may be provided by the terminal 125 itself or through a peripheral device 230 connected to the terminal through, for example a wired connection via the bottom connector 1127 (See FIG. 11) or through a wireless connection such as, for example, bluetooth or infrared. As described above, the motorized keys of the keypad 110 may provide a massaging effect for the user. In other embodiments the vibration generator 1123 (See FIG. 11) may be utilized to provide a soothing effect for the user. In alternate embodiments the phone may be equipped with any other suitable devices or features for stimulating the user such as, for example, heaters or cooling devices. In other embodiments the terminal may interact with peripheral devices 230 such as, for example, massage devices worn by the user, fans, heaters, etc. For example, the user may wear a backpack with a massage mechanism located adjacent the user's back that is activated through a suitable signal when a presentation is played by the user or otherwise outputted by the terminal 125. In alternate embodiments, massage devices, fans, heaters, or any other suitable peripheral device may be incorporated into any suitable user accessory such as other articles of clothing worn or carried by the user or any suitable portable device.

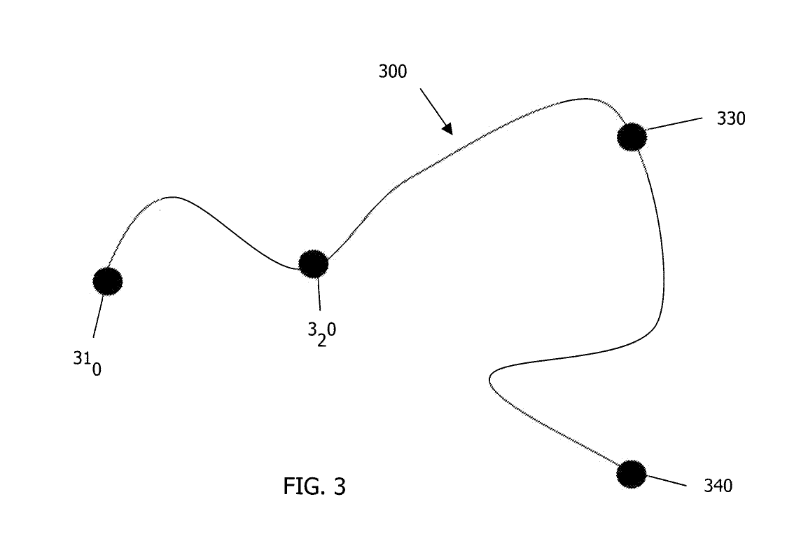

The duration of the presentations downloaded into the phone or transferred to the phone through the communications network may be set by the user, through any suitable setting menu. In other embodiments, the duration of the presentation may be a pre-defined period of time or they may be context sensitive (e.g. sensitive to events, time, location, etc). For example, FIG. 3 represents a time line 300 of, for example, a user's commute. The points 310-340 may represent time intervals or points along that commute. The commute may be a bus ride or such other suitable transportation mode, with start point 310 and end point 340. For example if travel time between points 310 and 340 takes fifteen minutes the user may set the duration of the presentation for fifteen minutes. In other embodiments, the user may set the duration of a first presentation between points 310 and 320, a second presentation between points 320 and 330 and a third presentation between points 330 and 340 where the duration of each presentation is a portion of the total commute time.

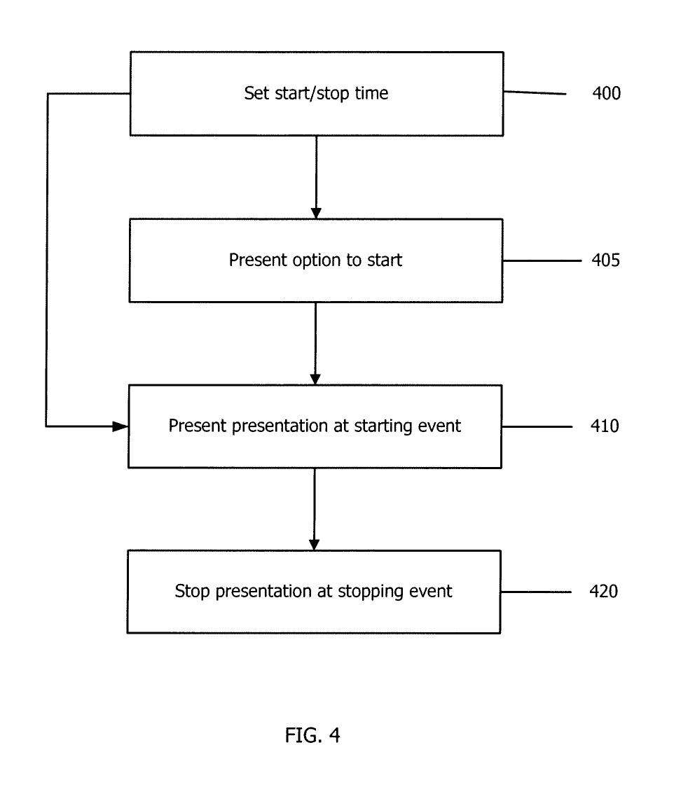

Referring to FIG. 4 in other embodiments, there may be a setting that allows the user to start the presentation at a certain time. For example, the user may configure the terminal so that the presentation is presented at any suitable time such as, for example, during a user's lunch break. There may be a suitable setting menu that allows the user to set a start time of the presentation and an end time of the presentation (FIG. 4, Block 400). For example, the user may set the start time for 12:00 p.m. and the end time for 12:30 p.m. When the user starts his/her lunch break at 12:00 p.m. the presentation may start. In other embodiments, the user may be prompted by the device 125 at the time the presentation is supposed to start with a question as to whether the user wants the presentation to begin (FIG. 4, Block 405). The presentation may be presented for the specified time duration (FIG. 4, Block 410) and end when the time duration expires (e.g. at 12:30 p.m.) (FIG. 4, Block 420). In alternate embodiments there may be a setting that would allow the user to set the start and stop times of the presentation in a randomized manner so that the user never knows when the presentation will start or stop.

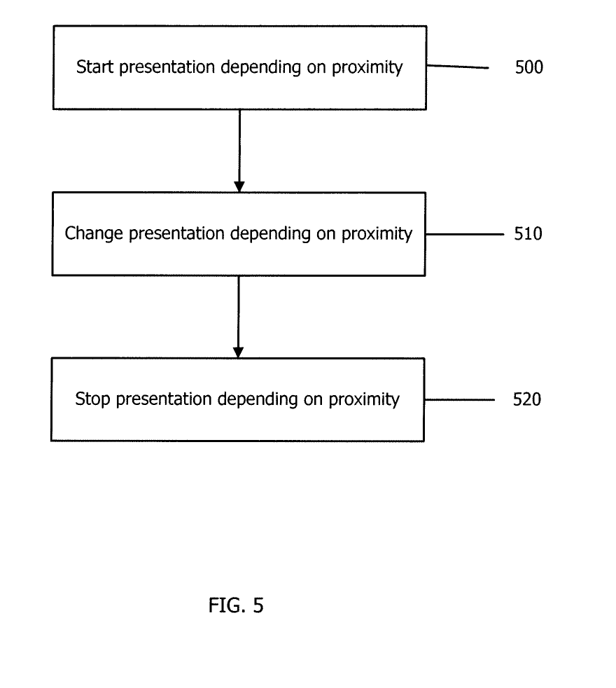

Referring now to FIGS. 3 and 5, the presentations may also be context sensitive. For example, if the user knows that the user will pass by a certain location (e.g. be in the proximity of the location) during the user's commute, for example point 310 the user can set the presentation to automatically start when the terminal passes that location (FIG. 5, Block 500). The user may also configure the terminal so that the presentation changes when a certain point is passed, such as, for example, points 320 and 330 (FIG. 5, Block 510). The user may further configure the terminal 125 so that the presentation automatically stops at a certain location such as, for example, point 340 (FIG. 5, Block 520). In other embodiments the user may manually start, change or stop the presentation.

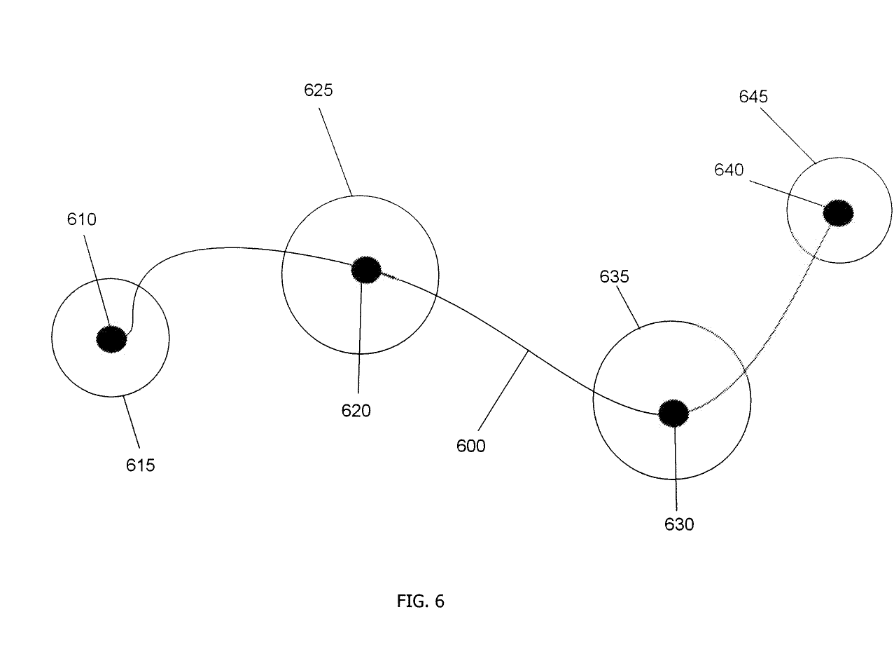

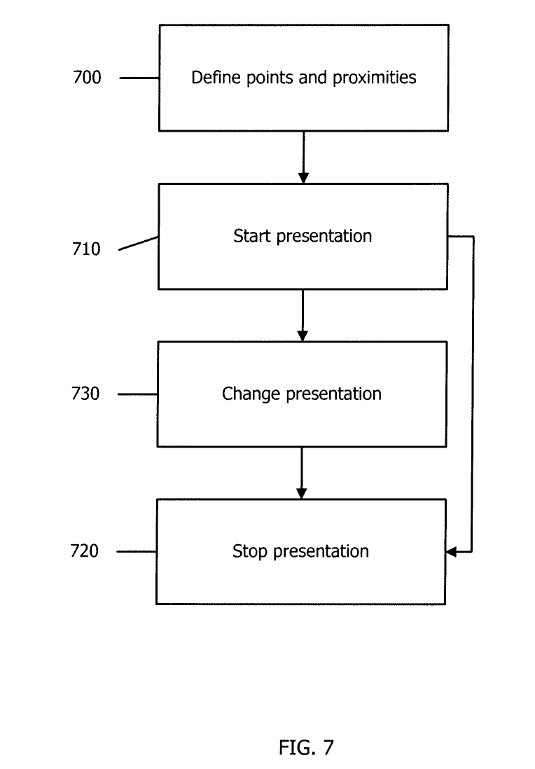

Referring now to FIGS. 6 and 7, the settings menu may allow the user to define points 610, 620, 630, 640 along a user's route 600 in any suitable manner, such as for example, street addresses or latitude and longitude. A proximity 615, 625, 635, 645 around these points may be set by the user (e.g. a perimeter of for example one mile around the points or the perimeter may be defined by a time of arrival to that point) (FIG. 7, Block 700). Although the proximities 615, 625, 635, 645 are shown in FIG. 6 as being diametrical, the proximities may have any suitable shape. The presentation may work in conjunction with, for example, a global positioning system (GPS) to determine the terminal's location and when the terminal is in the proximity of the points. The terminal may determine when it is proximate the points in any suitable manner, such as by comparing a position obtained from the GPS with a location stored in, for example a table in the memory 102 of the terminal 125. The determination of the location of the terminal may be automatic or it may be initiated by the user. The table may include any suitable information such as the location of the point along the route and a proximity around the point. In alternate embodiments, each of the points may broadcast a signal that may include a presentation which, when the terminal is proximate the point, the terminal may download and play or output that presentation.

The proximity may allow the terminal to automatically start, change or stop the presentation when it is determined that the terminal is within that proximity. When the terminal is proximate to a pre-defined point, such as point 610, the terminal may start the presentation (FIG. 7, Block 710) and stop the presentation (FIG. 7, Block 720) when the terminal is proximate point 640. In other embodiments, the user may set a first presentation to be active between points 610 and 620, a second presentation to be active between points 620 and 630 and a third presentation to be active between points 630 and 640 where the presentation changes from one to the next when the terminal passes proximate to each of the corresponding points (FIG. 7, Block 730).

The terminal 125 may also be configured so that the presentations played or output through the terminal 125 coincide with a type of location or event. For example, if point 610 is a spa, point 620 is a museum and point 630 is a flower garden, the terminal may determine that the first presentation is to have, for example, a water type theme to coincide with the spa setting, the second presentation is to have a classical theme to coincide with the museum setting and the third presentation is to have a outdoor theme to coincide with the flower garden. In this example, there may be a settings menu that allows the user to associate each point with a type of location. In alternate embodiments, the themes may coincide and change according to any suitable location. In other embodiments, the terminal may be configured to present a presentation when the user gets off from work or upon any other suitable event.

The termination of the presentation either through the timed duration or context identification may indicate to the user that it is time to, for example, get off the bus or get off of any other mode of transportation. The ending of the presentation may be a gradual ending such as for example, the sounds, visual stimuli and tactile feedback may gradually become less intense. In other embodiments the termination of the presentation may be sudden. In alternate embodiments the duration of the presentation(s) may be automatically set by the terminal 125 or some external device in communication with the terminal.

The presentations may also be context sensitive depending on the time of day. For example, when the user is about to go to sleep for the night a night time theme may be presented to the user through the terminal 125 to aid the user in falling asleep. The night time presentation may stop, for example, after a pre-determined amount of time or after suitable sensors detect the user is sleeping. In alternate embodiments, any suitable presentation may be activated so that the user is relaxed at any point during the day even when the user is not commuting.

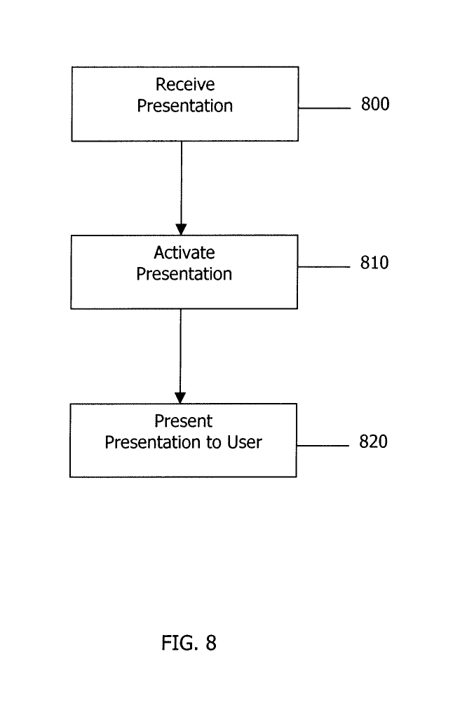

In operation, a presentation may be received in the terminal 300 in any suitable manner as described above (FIG. 8, Block 800). The user may activate the presentation or the presentation may be activated based on some outside stimulus, such as for example a certain location, time of day and the like (FIG. 8, Block 810). The presentation may be presented for a pre-defined duration of time or until an event occurs as described above or until the user decides to stop the presentation (FIG. 8, Block 820).

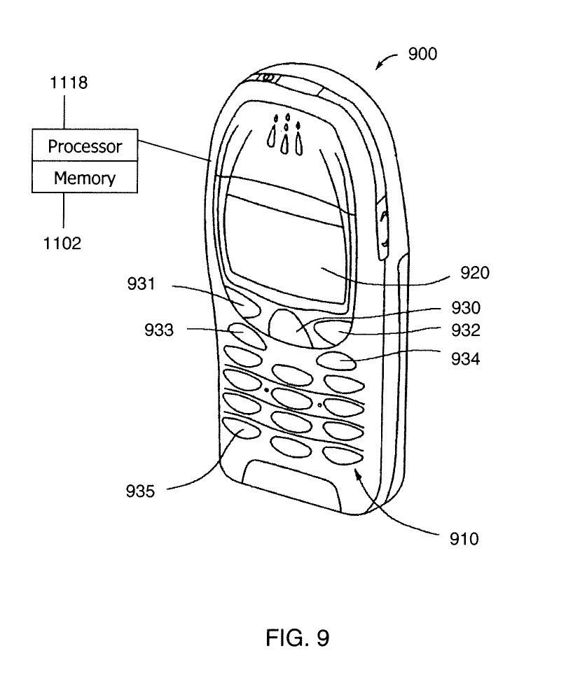

One embodiment 900 of a terminal 125 in which the described embodiments may be employed is illustrated in more detail in FIG. 9. The terminal or mobile communications device 900 may have a keypad 910 and a display 920. The keypad 910 may include any suitable user input devices such as, for example, a multi-function/scroll key 930, soft keys 931, 932, a call key 933 and end call key 934 and alphanumeric keys 935. To provide the tactile feedback mentioned above, the terminal 900 may be provided with a motorized keypad where the keys on the keypad move in and out of the terminal in, for example, an oscillating manner to massage, for example the hands of a user. The display 920 may be any suitable display, such as for example, a touch screen display or graphical user interface. The display may be integral to the device 900 or the display may be a peripheral display connected to the device 900. A pointing device, such as for example, a stylus, pen or simply the user's finger may be used with the display 920. In alternate embodiments any suitable pointing device may be used. In other alternate embodiments, the display may be a conventional display. The device 900 may also include other suitable features such as, for example, a camera, loud speaker, connectivity port or tactile feedback features. The camera (video or still) of the terminal 900 may be used to obtain the visualizations described above. The mobile communications device may have a processor 1118 connected to the display for processing user inputs and displaying information on the display 920. A memory 1102 may be connected to the processor 1118 for storing any suitable information and/or applications associated with the mobile communications device 900 such as phone book entries, calendar entries, web browser, etc.

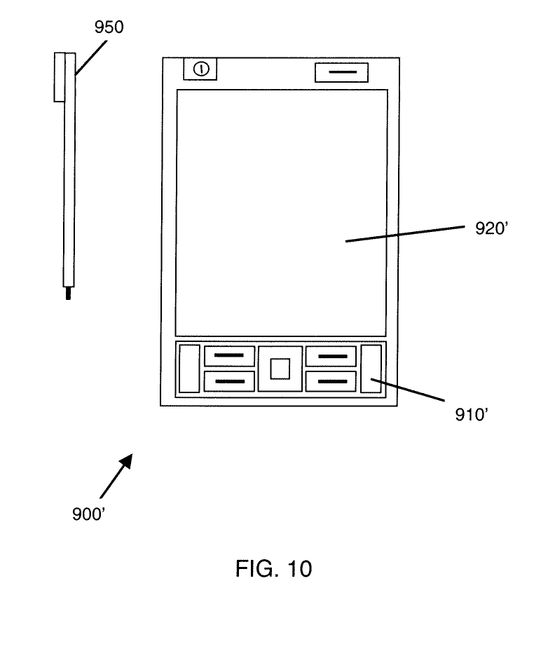

In one embodiment, the device 125 may be for example, a PDA style device 900′ illustrated in FIG. 10. The PDA 900′ may have a keypad 910′, a touch screen display 920′ and a pointing device 950 for use on the touch screen display 920′. In still other alternate embodiments, the device may be a personal communicator, a tablet computer, a laptop or desktop computer, a television or television set top box or any other suitable device capable of containing the display 920 and supported electronics such as the processor 1118 and memory 1102.

FIG. 11 illustrates in block diagram form one embodiment of a general architecture of a mobile device in which the aspects of the disclosed embodiment may be implemented. The mobile communications device may have a processor 1118 connected to the display 1103 for processing user inputs and displaying information on the display 1103. The processor 1118 controls the operation of the device and can have an integrated digital signal processor 1117 and an integrated RAM 1115. The processor 1118 controls the communication with a cellular network via a transmitter/receiver circuit 1119 and an antenna 1120. A microphone 1106 is coupled to the processor 1118 via voltage regulators 1121 that transform the user's speech into analog signals. The analog signals formed are A/D converted in an A/D converter (not shown) before the speech is encoded in the DSP 1117 that is included in the processor 1118. The encoded speech signal is transferred to the processor 1118, which e.g. supports, for example, the GSM terminal software. The digital signal-processing unit 1117 speech-decodes the signal, which is transferred from the processor 1118 to the speaker 1105 via a D/A converter (not shown).

The voltage regulators 1121 form the interface for the speaker 1105, the microphone 1106, the LED drivers 1101 (for the LEDS backlighting the keypad 1107 and the display 1103), the SIM card 1122, battery 1124, vibration generator 1123, the bottom connector 1127, the DC jack 1131 (for connecting to the charger 1133), the audio amplifier 1132 that drives the (hands-free) loudspeaker 1125 and any other suitable devices such as a camera.

The processor 1118 can also include memory 1102 for storing any suitable information and/or applications associated with the mobile communications device such as the presentations described herein, phone book entries, calendar entries, presentations, etc.

The processor 1118 also forms the interface for peripheral units of the device, such as for example, a (Flash) ROM memory 1116, the graphical display 1103, the keypad 1107, a ringing tone selection unit 1126, and an incoming call detection unit 1128. In alternate embodiments, any suitable peripheral units for the device can be included, such as for example massage units, fans, heaters, etc. that may interact with the terminal to facilitate the relaxation or mood modification of the user.

The software in the RAM 1115 and/or in the flash ROM 1116 contains instructions for the processor 1118 to perform a plurality of different applications and functions such as, for example, those described herein.

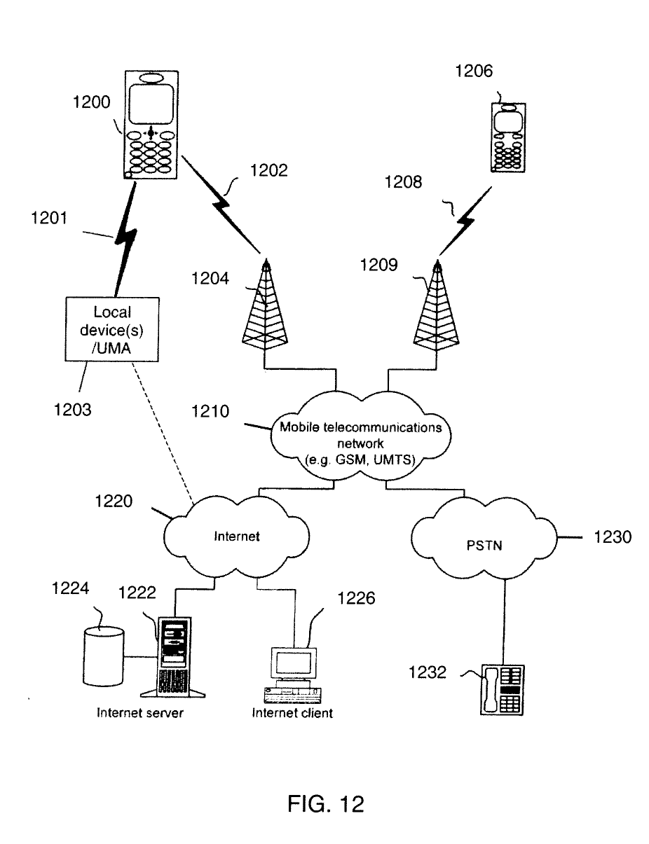

The terminals, such as for example, terminal 125 and terminal(s) 130 can communicate with each other through any suitable network such as for example, a cellular network for sending and receiving presentations or portions of presentations (e.g. sounds, videos, pictures, etc). FIG. 12 is a schematic illustration of a cellular telecommunications system, as an example, of an environment in which a communications device 1200 incorporating features of an exemplary embodiment may be applied. The communication device 1200 may be similar to terminal 1200 described above. In the telecommunication system of FIG. 12, various telecommunications services such as cellular voice calls, www/wap browsing, cellular video calls, data calls, facsimile transmissions, music transmissions, still image transmission, video transmissions, electronic message transmissions and electronic commerce may be performed between the mobile terminal 1200 and other devices, such as another mobile terminal 1206, a stationary telephone 1232, or an internet server 1222. It is to be noted that for different embodiments of the mobile terminal 1200 and in different situations, different ones of the telecommunications services referred to above may or may not be available. The aspects of the invention are not limited to any particular set of services in this respect.

The mobile terminals 1200, 1206 may be connected to a mobile telecommunications network 1210 through radio frequency (RF) links 1202, 1208 via base stations 1204, 1209. The mobile telecommunications network 510 may be in compliance with any commercially available mobile telecommunications standard such as GSM, UMTS, D-AMPS, CDMA2000, FOMA and TD-SCDMA.

The mobile telecommunications network 1210 may be operatively connected to a wide area network 1220, which may be the internet or a part thereof. An internet server 1222 has data storage 1224 and is connected to the wide area network 1220, as is an internet client computer 1226. The server 1222 may host a www/hap server capable of serving www/hap content to the mobile terminal 1200.

For example, a public switched telephone network (PSTN) 1230 may be connected to the mobile telecommunications network 1210 in a familiar manner. Various telephone terminals, including the stationary telephone 1232, may be connected to the PSTN 1230.

The mobile terminal 1200 is also capable of communicating locally via a local link 1201 to one or more local devices 1203. The local link 1201 may be any suitable type of link with a limited range, such as for example Bluetooth, a Universal Serial Bus (USB) link, a wireless Universal Serial Bus (WUSB) link, an IEEE 802.11 wireless local area network (WLAN) link, an RS-232 serial link, etc. The local devices 1203 can, for example, be various sensors that can communicate measurement values to the mobile terminal 1200 over the local link 1201. The above examples are not intended to be limiting, and any suitable type of link may be utilized. The local devices 1203 may be antennas and supporting equipment forming a WLAN implementing Worldwide Interoperability for Microwave Access (WiMAX, IEEE 802.16), WiFi (IEEE 802.11x) or other communication protocols. The WLAN may be connected to the internet. The mobile terminal 1200 may thus have multi-radio capability for connecting wirelessly using mobile communications network 1210, WLAN or both. Communication with the mobile telecommunications network 1210 may also be implemented using WiFi, WiMax, or any other suitable protocols, and such communication may utilize unlicensed portions of the radio spectrum (e.g. unlicensed mobile access (UMA)).

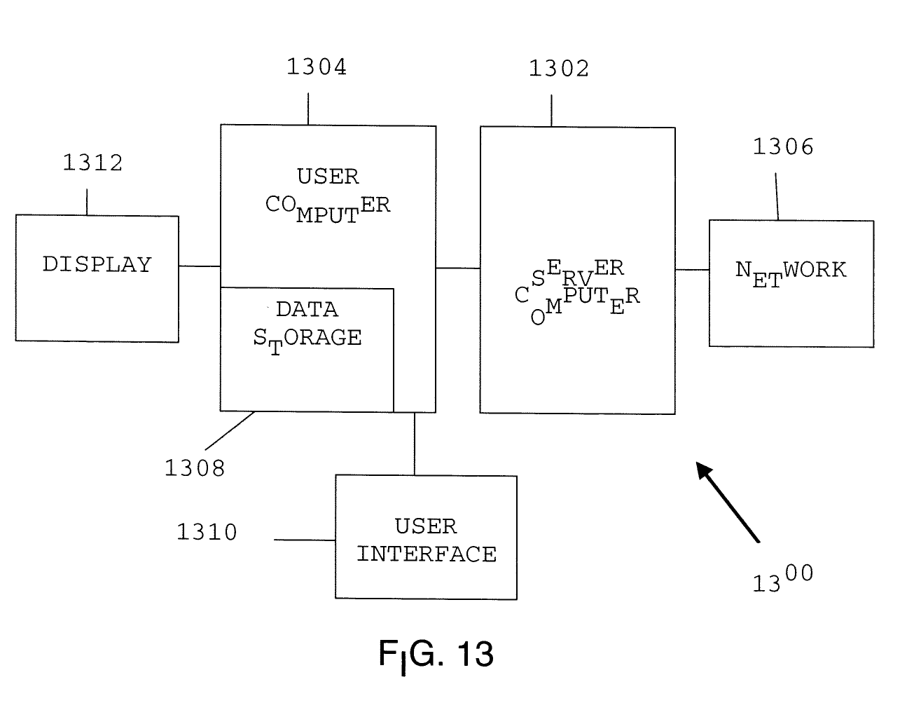

The disclosed embodiments may also include software and computer programs incorporating the process steps and instructions described above that are executed in different computers. FIG. 13 is a block diagram of one embodiment of a typical apparatus 1300 incorporating features that may be used to practice aspects of the invention. As shown, a computer system 1302 may be linked to another computer system 1304, such that the computers 1302 and 1304 are capable of sending information to each other and receiving information from each other. In one embodiment, computer system 1302 could include a server computer adapted to communicate with a network 1306. Computer systems 1302 and 1304 can be linked together in any conventional manner including, for example, a modem, hard wire connection, or fiber optic link. Generally, information can be made available to both computer systems 1302 and 1304 using a communication protocol typically sent over a communication channel or through a dial-up connection on ISDN line. Computers 1302 and 1304 are generally adapted to utilize program storage devices embodying machine readable program source code which are adapted to cause the computers 1302 and 1304 to perform the method steps disclosed herein. The program storage devices incorporating aspects of the invention may be devised, made and used as a component of a machine utilizing optics, magnetic properties and/or electronics to perform the procedures and methods disclosed herein. In alternate embodiments, the program storage devices may include magnetic media such as a diskette or computer hard drive, which is readable and executable by a computer. In other alternate embodiments, the program storage devices could include optical disks, read-only-memory (‘ROM’) floppy disks and semiconductor materials and chips.

Computer systems 1302 and 1304 may also include a microprocessor for executing stored programs. Computer 1302 may include a data storage device 1308 on its program storage device for the storage of information and data. The computer program or software incorporating the processes and method steps incorporating aspects of the invention may be stored in one or more computers 1302 and 1304 on an otherwise conventional program storage device. In one embodiment, computers 1302 and 1304 may include a user interface 1310, and a display interface 1312 from which aspects of the invention can be accessed. The user interface 1310 and the display interface 1312 can be adapted to allow the input of queries and commands to the system, as well as present the results of the commands and queries.

The embodiments described herein provide a way to impose any suitable effect on the user, such as a soothing, meditative or relaxing effect through several different media for the modification of a mood or state of mind of the user. For example the embodiments allow a user to relax during a commute or at any other suitable time in such a way so as to at least make it appear to other individuals that the user does not want to be disturbed. The embodiments disclosed herein may also indicate to a user that a certain event should occur, such as, for example, the user getting off a bus or train, the ending of a lunch break, etc. The embodiments also may assist a user in relaxing at any point during the day when the user is not commuting.

It should be understood that the foregoing description is only illustrative of the embodiments. Various alternatives and modifications can be devised by those skilled in the art without departing from the embodiments. Accordingly, the present embodiments are intended to embrace all such alternatives, modifications and variances that fall within the scope of the appended claims.

What is claimed is:

1. An apparatus comprising:
a speaker;
a display;
a processor in communication with the speaker and display; and
a memory module in communication with the processor for at least storing at least one presentation executable by the processor, wherein the presentation is configured to modify a mood of a user, and wherein the at least one processor is configured to send or receive the at least one presentation to or from another apparatus and to cause a presentation of at least one presentation to the user.

2. The apparatus of claim 1, wherein the processor is further configured to cause tactile feedback as part of the presentation that coincides with at least sounds or visual stimuli of the presentation.

3. The apparatus of claim 2, wherein the tactile feedback includes at least one of vibration, heat, massage and cooling.

4. The apparatus of claim 1, wherein the presentation includes at least one of a visual stimuli presented on the display and changes in the appearance of the apparatus.

5. The apparatus of claim 1, wherein the presentation is context driven.

6. The apparatus of claim 5, wherein processor is configured to cause the presentation to start or end upon certain events.

7. The apparatus of claim 5, wherein the processor is configured to cause the presentation to start or end depending on a location of the apparatus.

8. The apparatus of claim 5, wherein the processor is configured to cause the presentation to start or end depending on a time of day.

9. The apparatus of claim 5, wherein an ending of the presentation indicates to the user that a certain event is about to occur.

10. A method comprising:
sending at least one presentation from a first device to a second device;
receiving the at least one presentation in the second device; and
presenting through the second device the at least one presentation including at least one of sounds and visual stimuli to a user to modify a mood of the user.

11. The method of claim 10, wherein the presentation is received in the device via a message.

12. The method of claim 10, further comprising presenting tactile feedback to the user as part of the presentation, wherein the tactile feedback coincides with at least one of the sounds and visual stimuli.

13. The method of claim 12, wherein the tactile feedback includes at least one of vibration, heat, massage and cooling.

14. The method of claim 10, wherein the visual stimuli include at least one of a visual stimuli presented on the display and changes in the appearance of the device.

15. The method of claim 10, wherein the presentation starts or ends in dependence on certain events.

16. The method of claim 10, the presentation starts or ends depending on a location of the device.

17. The method of claim 10, wherein the presentation starts or ends depending on a time of day.

18. The method of claim 10, further comprising notifying a user that a certain event is about to occur by ending the presentation.

19. A computer program product comprising:
a computer useable medium having computer readable code means embodied therein for causing a computer to modify a mood of a user, the computer readable code means in the computer program product comprising:
computer readable program code means for causing a computer to send at least one presentation from a first device to a second device;
computer readable program code means for causing a computer to receive the at least one presentation in the second device; and
computer readable program code means for causing a computer to present through the second device the at least one presentation including at least one of sounds and visual stimuli to a user to modify a mood of the user.

20. The computer program product of claim 19, further comprising computer readable program code for causing a computer to present tactile feedback to the user as part of the presentation that coincides with at least one of the sounds and visual stimuli.

21. The computer program product of claim 19, wherein the presentation is context dependent.
